(19) United States
(12) Patent Application Publication
(10) Pub. No.: US 2022/0299184 A1
(43) Pub. Date: Sep. 22, 2022

(54) HIGH EFFICIENCY VEHICLE HEADLAMPS

(71) Applicant: Magna Closures Inc., Newmarket (CA)

(72) Inventors: Miu TRAIAN, Newmarket (CA); Gabriele Wayne SABATINI, Newmarket (CA)

(21) Appl. No.: 17/606,118

(22) PCT Filed: May 19, 2020
(86) PCT No.: PCT/CA2020/050672

§ 371 Date: Oct. 25, 2021

Related U.S. Application Data
(60) Provisional application No. 62/851,274, filed on May 22, 2019.

(51) Int. Cl. F21S 41/20; F21S 41/37; F21S 41/64; F21S 41/63; F21S 41/16; F21S 41/663

(52) U.S. Cl. CPC F21S 41/285; F21S 41/37; F21S 41/645; F21S 41/635; F21S 41/16; F21S 41/663; F21Y 2115/30

(57) ABSTRACT

A vehicle lamp including a plurality of solid state light emitters that emit light that passes through a cold mirror to be converted to human visible light by a conversion layer. Some converted light will exit the lamp in the desired direction. Some converted light will transmit toward the cold minor be reflected by the cold minor toward the exit of the lamp. A micro-optics layer is optically connected to the solid state light emitters to direct the light therefrom to the cold mirror. Controller is provided to control solid state light emitters and/or the controllable elements of microprism layer.

### CROSS-REFERENCE TO RELATED APPLICATIONS

This PCT International Patent Application claims the benefit of U.S. Provisional Application No. 62/851,274 filed May 22, 2019. The entire disclosure of the above application being considered part of the disclosure of this application and hereby incorporated by reference.

### FIELD

The present disclosure relates to generally to vehicle lamps, and more specifically, to improved efficiency for outputting light.

### BACKGROUND

Motor vehicle headlamps have shifted from incandescent lamps and high intensity discharge lamps (e.g., xenon electrical gas-discharge lamps) to more electrically efficient light emitting diode (LED) lamps. LED lamps typically provide greater lumens for less electrical energy, e.g., by producing less infrared or red bandwidth light as well as less heat. However, multiple LEDS provide a plurality of different light beams.

### SUMMARY

This section provides a general summary of the present disclosure and is not a comprehensive disclosure of its full scope or all of its features, aspects and objectives.

In accordance with one aspect of the disclosure, a light source emits light to a cold mirror to prevent light beams from being emitted in a non-desired direction while obscuring the light sources, which can be one or more point light sources, e.g., solid state light sources. In an example embodiment, a plurality of solid state light sources include light emitting diodes.

In accordance with another aspect of the disclosure, a vehicle lamp includes one or more coherent light sources and a lens, with aligned polarization with the light source, operably connected to the light sources. The lens operates to steer all of the light to a desired direction, e.g., the lens steers the light beams from the coherent light sources.

It is aspect of the disclosure to provide a vehicle lamp that includes a light source including solid state emitters. The solid state emitters are configured to emit light at a portion of a light spectrum. The vehicle lamp also includes a cold mirror receiving the light emitted from the solid state emitters and passing the light therethrough. In addition, the vehicle lamp includes a conversion layer receiving the light from the cold mirror. The conversion layer is configured to convert the light from the cold mirror to a visible light. A first portion of the visible light travels to the cold mirror and is reflected by the cold mirror to exit the vehicle lamp and a second portion of the visible light travels from the conversion layer out of the vehicle lamp. The vehicle lamp also includes a controller to control the solid state emitters.

In accordance with another aspect of the disclosure, the solid state emitters are each individually controllable by the controller.

In accordance with another aspect of the disclosure, the light emitted from the solid state emitters is an ultraviolet light, and wherein the conversion layer is configured to down convert the ultraviolet light to the visible light.

In accordance with another aspect of the disclosure, the vehicle lamp further comprises a lens intermediate the light source and the cold mirror to control a direction of the light from the solid state emitters.

In accordance with another aspect of the disclosure, the lens includes individual light controlling devices are each individually controllable to control the direction of the light from the light source.

In accordance with another aspect of the disclosure, the controller receives position information of another vehicle and controls the direction of the light by controlling the solid state emitters, the lens, or both to direct the light away from the another vehicle.

In accordance with another aspect of the disclosure, the lens include liquid crystal lenses.

In accordance with another aspect of the disclosure, the solid state emitters are controlled to adjust an amount of lumens being output from the light source and emit the light in a visible portion of the light spectrum.

In accordance with another aspect of the disclosure, the cold mirror includes alternating layers having different indexes of refraction.

It is aspect of the disclosure to provide a vehicle lamp assembly. The vehicle lamp assembly includes a light source including solid state emitters. The solid state emitters are configured to emit electromagnetic radiation. The vehicle lamp assembly also includes a micro-optic layer optically connected to the light source, wherein each solid state emitter is optically coupled to the micro-optic layer to control a direction of the electromagnetic radiation emitted from the light source. In addition, the vehicle lamp assembly includes a cold mirror receiving the electromagnetic radiation emitted from the solid state emitters from the micro-optic layer and passing the electromagnetic radiation therethrough. The vehicle lamp assembly additionally includes a conversion layer receiving the electromagnetic radiation from the cold mirror, wherein the conversion layer is configured to convert the electromagnetic radiation to a visible light, a first portion of the visible light traveling to the cold mirror and being reflected by the cold mirror to exit the vehicle lamp assembly and a second portion of the visible light traveling from the conversion layer out of the vehicle lamp assembly. The vehicle lamp assembly also includes a controller configured to control the solid state emitters.

In accordance with another aspect of the disclosure, the controller is further configured to control the on state of each of the solid state emitters.

In accordance with another aspect of the disclosure, the controller receives sensed signals from vehicle sensors and controls operation of each of the solid state emitters.

In accordance with another aspect of the disclosure, the micro-optic layer is a microprism layer including a plurality of controllable elements to direct an electromagnetic radiation output from the solid state emitters, and wherein the controller is further configured to control a state of the plurality of controllable elements.

In accordance with another aspect of the disclosure, the micro-optic layer includes a plurality of liquid crystal lenses.

In accordance with another aspect of the disclosure, the solid state emitters include an array of vertical-cavity surface-emitting laser elements.

It is another aspect of the disclosure to provide a vehicle lamp assembly. The vehicle lamp assembly includes a housing mounted to a vehicle and an optical device mounted in the housing. The optical device includes a light source including solid state light emitters, the solid state light emitters configured to emit a coherent light. The optical device also includes a polarizer optically connected to the light source to polarize the coherent light emitted from the light source. In addition, the optical device includes a spatial light modulator optically connected to the polarizer and configured to modulate the coherent light polarized by the polarizer to optically steer the coherent light polarized by the polarizer.

In accordance with another aspect of the disclosure, the spatial light modulator is a liquid crystal spatial light modulator.

In accordance with another aspect of the disclosure, the liquid crystal spatial light modulator includes a Liquid Crystal on Silicon device comprising a plurality of liquid crystal lenses.

In accordance with another aspect of the disclosure, the coherent light polarized by the polarizer is aligned with a polarization alignment direction of the plurality of liquid crystal lenses.

In accordance with another aspect of the disclosure, the spatial light modulator is a polarization sensitive spatial light modulator having a polarization alignment direction, wherein the coherent light polarized by the polarizer is aligned with the polarization alignment direction of the spatial light modulator.

In accordance with another aspect of the disclosure, the vehicle lamp further comprises a controller to control the solid state light emitters and the spatial light modulator.

In accordance with another aspect of the disclosure, the vehicle lamp includes a dielectric mirror receiving the coherent light from the spatial light modulator and passing the coherent light therethrough. The vehicle lamp also includes a conversion layer receiving the coherent light from the dielectric mirror, wherein the conversion layer is configured to convert the coherent light from the dielectric mirror to a visible light, a first portion of the visible light traveling to the dielectric mirror and being reflected by the dielectric mirror to exit the vehicle lamp assembly and a second portion of the visible light traveling from the conversion layer out of the vehicle lamp assembly.

In accordance with another aspect of the disclosure, the polarizer includes a beam splitting polarizer configured to polarize the coherent light into a first polarized coherent light and a second polarized coherent light. The polarizer also includes a half wave plate polarizer configured to polarize the second polarized coherent light into a third polarized coherent light, wherein a polarization of the first polarized coherent light and the third polarized coherent light are the same and form a polarized coherent light.

It is yet another aspect of the disclosure to provide an optical device for a vehicle lamp assembly. The vehicle lamp assembly includes a light source including solid state light emitters. The solid state light emitters are configured to emit coherent light. The vehicle lamp assembly includes a polarizer optically connected to the light source to polarize the coherent light emitted from the light source. In addition, the vehicle lamp assembly includes a spatial light modulator optically connected to the polarizer and configured to modulate the coherent light polarized by the polarizer to optically steer the coherent light polarized by the polarizer.

It is another aspect of the disclosure to provide a method of optically steering light emitted from a vehicle lamp. The method includes the step of generating a coherent light using a light source. Next, aligning a polarization direction of the coherent light with a polarization alignment direction of a spatial light modulator using a polarizer to form a polarized coherent light. The method also includes the step of modulating the polarized coherent light using the spatial light modulator to optically steer the polarized coherent light emitted from the light source.

In accordance with another aspect of the disclosure, the step of aligning the polarization direction of the coherent light with the polarization alignment direction of the spatial light modulator using the polarizer to form the polarized coherent light includes the step of polarizing the coherent light into a first polarized coherent light and a second polarized coherent light using a beam splitting polarizer of the polarizer. Next, polarizing the second polarized coherent light into a third polarized coherent light using a half wave plate polarizer of the polarizer, wherein a polarization of the first polarized coherent light and the third polarized coherent light are the same and form the polarized coherent light.

In accordance with another aspect of the disclosure, the method further includes the steps of receiving the polarized coherent light using a cold mirror and allowing a first band of light with a first range of wavelengths to pass therethrough and reflecting a second band of light with a second range of wavelengths different than the first range of wavelengths using the cold mirror.

In accordance with another aspect of the disclosure, the method further includes the steps of receiving the first band of light using a conversion layer and converting the first band of light to a converted light with a wavelength in a visible wavelength range using the conversion layer.

In accordance with another aspect of the disclosure, the method further includes the step of focusing the coherent light from the light source using a microlens array adjacent the light source.

In accordance with another aspect of the disclosure, the light source includes solid state emitters. The method further includes the steps of receiving sensed signals from vehicle sensors in communication with the vehicle lamp and adjusting an amount of light output by the each of the solid state emitters based on sensed signals from the vehicle sensors.

It will be appreciated that any of the aspects of this summary can be combined with other aspects in this summary as well as with the various embodiments described below.

### DRAWINGS

Other advantages of the present disclosure will be readily appreciated, as the same becomes better understood by reference to the following detailed description when considered in connection with the accompanying drawings wherein:

FIG. 1 shows a schematic view of a vehicle and with a headlamp according to an aspect of the present disclosure;

FIG. 2 shows a schematic view of a lighting system according to an aspect of the present disclosure;

FIG. 3 shows a schematic view of a headlamp according to an aspect of the present disclosure;

FIG. 4 shows schematic view a lighting system according to an aspect of the present disclosure;

FIG. 5 shows a schematic view a lighting system according to an aspect of the present disclosure;

FIG. 6 shows a schematic view of a lighting system according to an aspect of the present disclosure;

FIG. 7 shows a schematic view of a lighting system according to an aspect of the present disclosure;

FIGS. 8A and 8B show an operation state of a headlamp, respectively, according to an aspect of the present disclosure;

FIG. 9A shows a schematic view of a lighting system according to an aspect of the present disclosure;

FIG. 9B illustrates the operation of the lighting system of FIG. 9A according to an aspect of present disclosure;

FIG. 10 shows a schematic view of a lighting system according to an aspect of the present disclosure;

FIG. 11 shows a schematic view of a lighting system according to an aspect of the present disclosure;

FIG. 12 shows a schematic view of a lighting system according to an aspect of the present disclosure;

FIG. 13 shows a schematic view of a lighting system according to an aspect of the present disclosure;

FIG. 14 shows a simplified schematic view of a vehicle according to an aspect of the present disclosure;

FIG. 15 shows a schematic view of a lighting system according to an aspect of the present disclosure;

FIG. 16 shows a schematic view of a lighting system according to an aspect of the present disclosure;

FIG. 17 shows a schematic view of a lighting system according to an aspect of the present disclosure; and

FIG. 18 illustrates steps of a method of optically steering light emitted from a vehicle lamp according to an aspect of the present disclosure.

### DETAILED DESCRIPTION

In general, example embodiments of vehicle lighting, e.g., headlamps, having solid state light sources and integrated beamforming in accordance with the teachings of the present disclosure will now be disclosed. The example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the present disclosure. In some example embodiments, well-known processes, well-known device structures, and well-known technologies are not described in detail, as they will be readily understood by the skilled artisan in view of the disclosure herein.

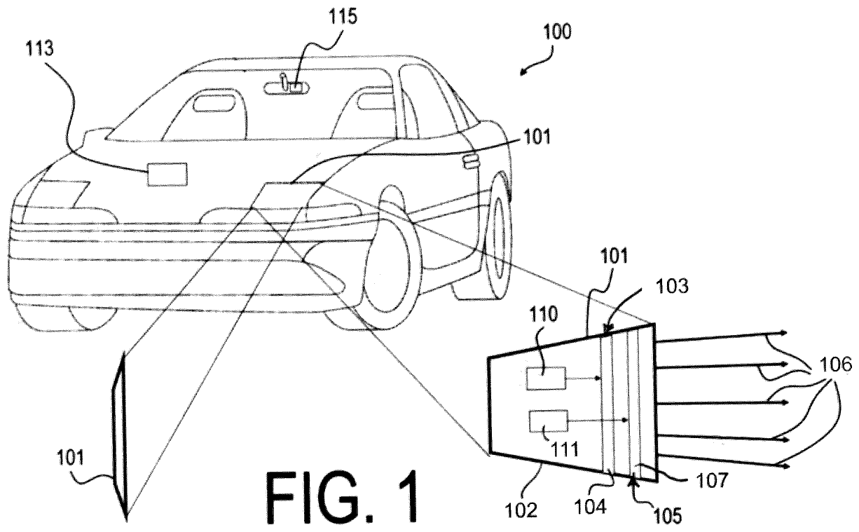

FIG. 1 shows a schematic view of a vehicle 100 and with a thin headlamp 101 with solid state components. The vehicle 100 can include one or more headlamps 101 each contained within a housing 102. The headlamps 101 emit light to illuminate the region in front of the vehicle 100. The headlamps 101 can illuminate the roadway as well as structures, such as oncoming vehicles, roadway, road signs, in front of the vehicle. The headlamps 101 can include a light source 103 with a matrix of hundreds or thousands of solid state light emitters 104, such as, but not limited to, a plurality of light emitting diodes. A lens 105 is optically coupled to an emitting side of the solid state light emitters 104. The lens 105 is an optical device configured to adjust distribution of rays of light from the matrix of solid state light emitters 104. The lens 105 can operate means of refraction effects occurring at a first, input surface to which emitted rays of light from the emitters strike and a second, output surface from which directed rays of light 107 emerge. The lens 105 can, for example, include a matrix or plurality of individually controllable light controlling devices 107 (e.g., microlenses) with each light emitter 103 being associated with a single one of the plurality of individually controllable light controlling devices 107 (e.g., microlens).

Circuitry is provided to control operation of the one or more headlamps 101. A light driver 110 controls each of the emitters 104 in the matrix or light source 103, to individually activate or turn on and cause the emitters 104 to emit light. The light driver 110 includes circuitry to process input according to instructions to generate light commands for controlling the matrix 103 of light emitters 104. A lens driver 111 drives each of the plurality of light controlling devices 107 (e.g., microlenses) in the lens 105 to control the direction of the light ray from each emitter 104. The lens driver 111 includes circuitry to process input according to instructions to generate lens commands for controlling the the plurality of light controlling devices 107 in the lens 105. A body control module (BCM) 113 coordinates different operations of the headlamp(s) 101 by sensing the environment and other sensed signals in the vehicle 100.

The vehicle 100 can include vehicle sensors including a light sensor 115, which can sense the ambient light and light from another vehicle, e.g., reflected light from the headlamps 101 or light emitted by an oncoming vehicle. The light sensor 115 can send light related information in an electrical signal to BCM 113. The BCM 113 is in electrical communication with the light sensor 115 and the light driver 110 and the lens driver 111. The BCM 113 can process the light information signals from the light sensor 115 to control operation of the light emitters 104 and the lens 105, e.g., through control signals to the drivers 110, 111.

In an example embodiment, the headlamp 101 is ultrathin, e.g., one inch or less or even less than ¼ inch in thickness. The use of solid state layers including the matrix of light emitters 104 and lens 105 allows the headlamp 101 to be ultrathin.

In an example embodiment, the matrix of light controlling devices 107 (e.g., microlenses) are solid state devices, lenses, prisms, or the like. The light controlling devices 107 are optically coupled to the matrix of light sources 103 to beam form the light 107 emitted from the lamp 101. In an example embodiment, a quantity light controlling devices 107 is a one-to-one match with a quantity of light emitters 104 of the light source 103. In an example embodiment, a quantity of light controlling devices 107 is a one-to-a small number (N) match with a quantity of light emitters 104. The small number N, for example, can be equal to or less than sixteen, equal to or less than eight, equal to or less than four, or equal to or less than two.

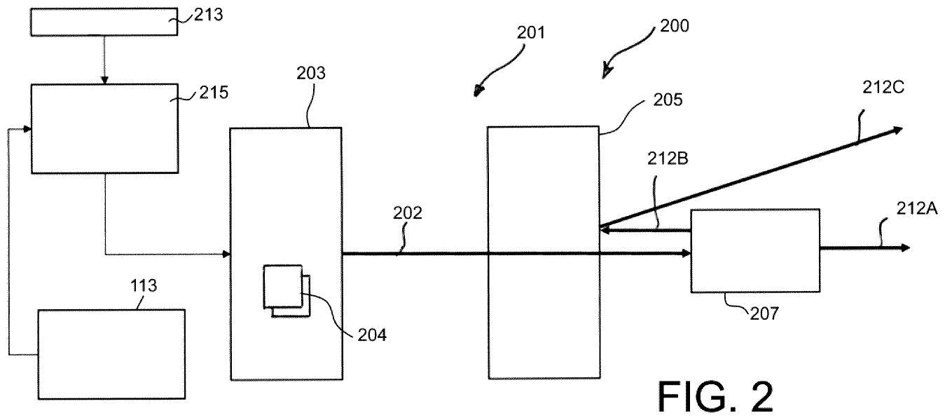

FIG. 2 shows a schematic view of a lighting system 200 according to an aspect of the present disclosure. The lighting system 200 can be a component of the vehicle 100 and includes a light emission assembly 201 configured to emit light 202 to illuminate the environment around the vehicle 100 or within the vehicle 100. The assembly 201 includes a light source 203, which can include one or more solid state light emitters 204, e.g., light emitting diodes, coherent light sources, and the like. The term “light” is used herein to refer to electromagnetic radiation, which may be visible or non-visible, and which may have various wavelengths over different spectral ranges. For example, emitters 204 of the light source 203 may be configured to emit electromagnetic radiation in the non-visible spectrums related to the non-visible infrared, or ultraviolent spectral ranges, as non-limiting examples. The solid state emitters 204 of the light source 203 can include an array or a plurality of vertical-cavity surface-emitting laser (VCSEL) diodes, which emit a laser beam perpendicular to a top surface of the VCSEL diode. Visible light for humans has a wavelength of about 400-700 nm. Some solid state light sources can be more efficient at emitting light outside the human visible light bandwidth. For example, some VCSEL emit light VCSELs in a wavelength range from 650 nm to 1300 nm. Such VCSEL are typically based on gallium arsenide (GaAs) wafers with distributed Briggs reflectors formed from GaAs and aluminum gallium arsenide (AlxGa(1−x)As). These types of light sources emit some light in the human visible range but a significant portion of the emitted light is in the infrared range and would not be visible to humans. Other types of light sources emit light that is shifted toward the blue or ultraviolet range. A measure of light distribution from a light source may be a relative power distribution, which has a significant portion of the power in the emitted light outside the visible spectrum or concentrated in a single sub-band, which is not perceived by humans as white light. A limited wavelength or a limited relative power distribution of light limits the use of some types of VCSELs when the illumination is for use by humans. Moreover, the light emitted from such light sources would be perceived as red or blue and not a broad band, i.e., white, light.

A cold mirror 205 is positioned on an emission side of the light source 203 (e.g., the top surface of the VCSEL diode) to receive light 202 emitted from the light source 203. The light 202 can include a significant band of light and light energy outside human perception. The cold mirror 205 is configured to allow certain wavelength bands of light (i.e., a first band of light with a first range of wavelengths) to pass there through, e.g., infrared (“IR”), blue light and the like, and reflects light in other wavelengths (i.e., a second band of light with a second range of wavelengths different than the first range of wavelengths). The cold mirror 205 is an example of a dielectric mirror or dichroic filter, e.g., a Bragg mirror. The cold mirror 205 operates to reflect visible wavelengths of light but transmit longer-wave infrared or shorter-wave ultraviolet radiation. The cold mirror 205 can operate as a dichroic filter to accurately and selectively pass light of a small range of colors (e.g., frequency pass bands) while reflecting other colors (e.g., frequency reflection bands). Dichroic filters can filter light from a white light source to produce light that is perceived by humans to be highly saturated (intense) in color. The cold mirror 205 operates to allow the light 202 to pass from the light source 203 to a converting material layer 207.

The converting material layer or simply conversion layer 207 receives the light 202 and operates to convert a received light 202 (e.g., the light passed through the cold mirror 205) to a visible wavelength light 212. The light 212 is output to illuminate the environment outside the light assembly 201. The conversion layer 207 can be doped with certain dopants to convert light from a wavelength band to a visible wavelength band. In an example embodiment, the dopant includes quantum dots. Quantum dots can be nanometer size particles whose energy states are dependent on the size of the quantum dot. For example, in semiconductors quantum dots are closely related to the size and shape of the individual semiconductor crystal. Generally, the smaller the size of the crystal, the larger the band gap, the greater the difference in energy between the highest valence band and the lowest conduction band becomes. Therefore, more energy is needed to excite the dot, and concurrently, more energy is released when the crystal returns to its resting state. Quantum dots represent one way to down convert ultraviolet light to a targeted color emission, for example a green light emission or red light emission. The conversion layer 207 does not control the direction of the converted or visible wavelength light 212 and emits some light beams 212A of the visible wavelength light 212 out of the light assembly 201 and some light beams 212B back toward the cold mirror 205. The cold mirror 205 then reflects the light beams 212B outwardly from the light assembly 201 as light beams 212C. The cold mirror 205 is arranged so that visible light 212 from the conversion layer 207 is reflected onto an object in the environment to be illuminated, while infrared radiation or ultraviolet radiation is transmitted through the cold mirror 205 toward the conversion layer 207.

The lighting system 200 further includes a power source 213 and a light controller 215. The light controller 215 is operably connected to the body control module (BCM) 113 and receives control signals from the BCM that are inputs to controlling the light emitted from the light assembly 201. The light controller 215 can include circuitry (e.g., including a microprocessor) operable connected to a memory that stores instructions for processing inputs and outputting control signals to the light assembly 201 control operation of the light assembly. In an example embodiment, the light source 203 is the only active component and it receives the control signals. The cold mirror 205 and the converting layer 207 can be passive components. The power source 213 can include a vehicle battery and circuitry to condition the power signal to a certain voltage or covert to an AC signal. In an example embodiment, the power source 213 is connected to both the controller 215 and the light source 203 to power both components.

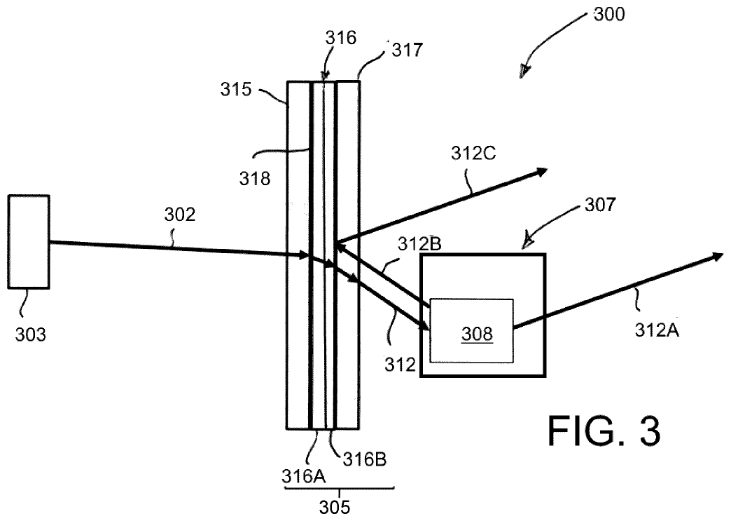

FIG. 3 shows a schematic view of a lamp 300 according to an aspect of the present disclosure. The lamp 300 can be a component of the vehicle 100, e.g., a headlamp or other light used in or on the vehicle 100. In an example embodiment, the lamp 300 can be used as the light emission assembly 201. Reference numbers for similar components and structures are designated using similar numbers with the most significant digit changed from “2” to “3.” A light source 303 can provide light 302. The light 302 can be shifted to the blue end of the spectrum, e.g., shorter wavelengths or have a higher relative power distribution in the blue or ultraviolet wavelengths. Light 302 passes through the cold mirror 305 and impinges the conversion layer 307. The conversion layer 307 includes a plurality of phosphor particles 308 as a dopant. The light 302 excites the phosphor particle 308, which in turn emits a broader light spectrum in the visible light. Some light 312A exits to illuminate the environment. Some light 312B is directed back to the cold mirror 307, which reflects the light 312C to also illuminate the environment.

The cold mirror 305 can be an all-polymeric cold mirror which reflects visible wavelengths while transmitting a substantial portion of infrared wavelengths or a substantial portion of ultraviolet wavelengths. In an example, embodiment, the cold mirror 305 includes a sufficient number of alternating layers 315, 316, 317 of at least first and second diverse polymeric materials such that at least 50% of peak reflecting visible light of a wavelength of between about 380-680 nm incident on the mirror 305 is reflected. In an example embodiment, at least 50% of infrared light between about 680-2000 nm is transmitted through the cold mirror 305. The cold mirror 305 includes a first skin layer 315, an intermediate structure 316, and a second skin layer 317. The first skin layer 315 faces the light source 303 and may be mechanically fixed to the light source 303. The first skin layer 315 receives the light from the light source 303. The second skin layer 317 is spaced from a remote side 318 of the first skin layer 315 and may receive light passing through the cold mirror 305 or from the light conversion layer 307. The first and second skins 315, 317 support the intermediate structure 316. The intermediate structure 316 may include a plurality of alternating layers 316A, 316B. Specifically, a first intermediate layer 316A of the alternating layers has a first index of refraction. A second intermediate layer 316B of the alternating layers has a second index of refraction, which is different than the first index of refraction, e.g., with a mismatch of at least 0.03. The first and second intermediate layers of the intermediate structure can be polymer layers. The layers 315, 316, 317 of the cold mirror 305 can be the mirrors and can be readily coextruded and can have larger surface areas relative to their thicknesses. The cold mirror 305 can be formed into simple or complex shapes either during extrusion or by post-forming operations such as thermoforming. In addition, they can be laminated to polymeric or nonpolymeric substrates for a variety of vehicle lighting applications.

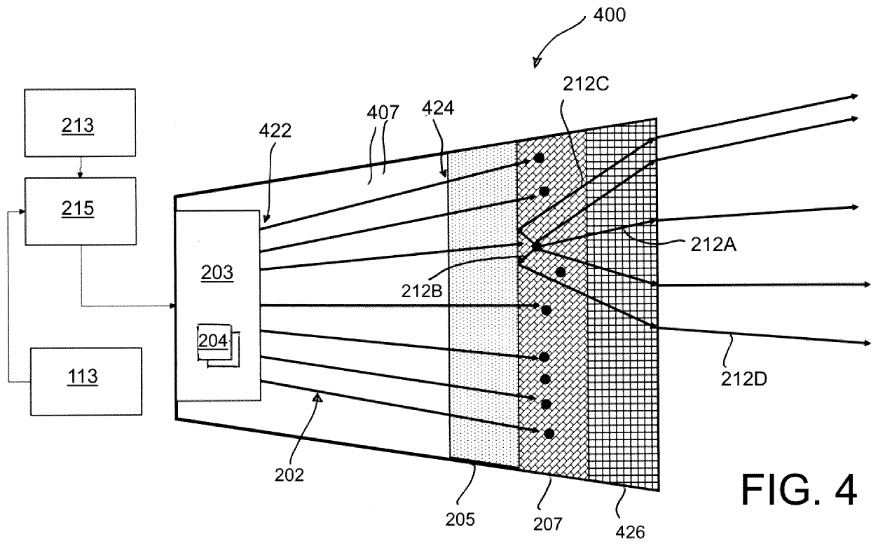

FIG. 4 shows a simplified schematic view of a lighting system 400 according to an aspect of the present disclosure. The lighting system 400 can be a lighting component of a vehicle. The lighting system 400 is similar to the lighting system 200 shown in FIG. 2. The same parts are designated with the same reference numbers. The present description of the light system 400 will focus on the differences. The light source 203 is followed, optically, by a lens 420. The lens 420 can be the medium that delivers the light 202 to the cold mirror 205. The lens 420 is positioned between the light source 203 and the cold mirror 205. The lens 420 is an optical device configured to adjust distribution of rays of light 202. The lens 420 can operate as a means of refraction with effects occurring at a first, input surface 422 to which rays of light from the light source 203 strike and a second, output surface 424 from which rays of light emerge. The lens 420 can include a plurality of individually controllable light refractors or controlling devices 407 (e.g., microlenses) with each light emitter 204 of the light source 203 being associated with a single one of the plurality of individually controllable light controlling devices 407 (e.g., microlens). The light refractors or controlling devices 407 in the lens 420 can include micro-optical devices, such as microprisms, microlenses, beam splitters, or the like, and may be provided in a micro-optic layer in an assembly. The light refactors or controlling devices 407 can include a plurality of microelectromechanical (MEMS) devices systems. The light refractors or controlling devices 407 can also be micro-optical devices formed using a LIGA (Lithographie, Galvanoformung, Abformung) process in the body of a base polymer, e.g., polymethyl methacrylate. In an example embodiment, lens 420 can also include a Fresnel lens.

A headlamp lens 426 receives the light 212A, 212C from the cold mirror 205 and converting material layer 207 and further directs the light to output light 212D to the environment. The lens 426 can include various structures to focus and guide light.

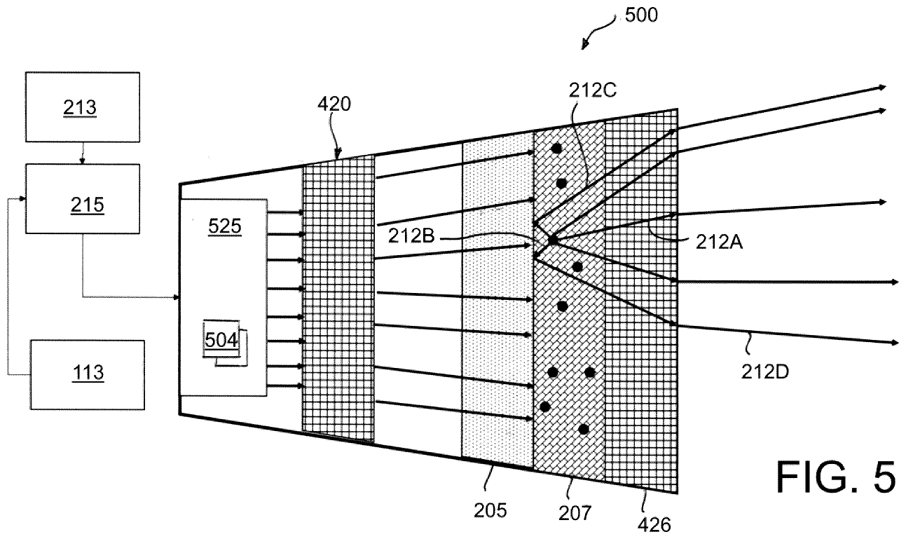

FIG. 5 shows a simplified schematic view of a lighting system 500 according to an aspect of the present disclosure. The lighting system 500 can be a component of the vehicle 100. The lighting system 500 is the same as the lighting system 400 except that the light source is a solid state laser array 525. The laser array 525 includes the plurality of solid state light emitters 504, e.g., VCSEL emitters. The lens 420 can be integrated into a same package as the laser array 525. The laser array 525 can emit blue light or red light. The blue light can include energy peaks in the blue or ultraviolet wavelengths. The red light can include energy peaks in the red or infrared wavelengths. The laser array 525 outputs coherent light, e.g., light having a same wavelength. Each of the emitters 504 in the laser array 525 can be a point source light.

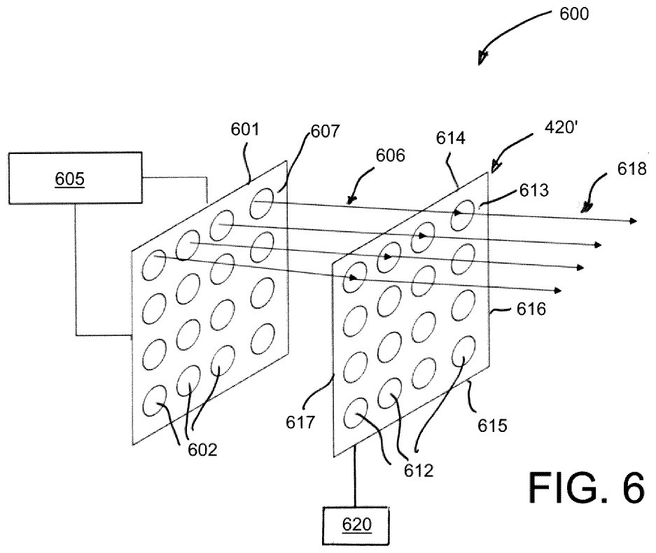

FIG. 6 shows a schematic view of a solid state lamp 600 according to an aspect of the present disclosure. The lamp 600 can be a component of the vehicle 100 and be a light source in the vehicle 100. The lamp 600 includes an array or matrix 601 of solid state light sources 602 positioned in the lamp 600 that are individually addressable (i.e., controlled individually), e.g. lasers or light emitting diodes. A light source array controller 605 is connected to the matrix 601 and controls operation of the each of the light sources 602 by outputting control signals and/or drive signals to control each of the solid state light sources 602. The controller 605 includes logic circuitry and signal drive circuitry to send control signals to determine whether any individual one of the light sources 602 is activated or on to emit light. Each light source 602 when activated emits light 606. For ease of illustration, a top row 607 of the light sources 602 is illustrated as emitting light 606. It will be further recognized that the FIG. 6 embodiment shows a reduced number of light sources 602 for ease of illustration. It is within the scope of the example embodiment shown in FIG. 6 to include hundreds, thousands, millions of light sources 602. The light sources 602 can emit coherent light beams 606.

The lamp 600 further includes a lens 420′ that is optically coupled to an emission side of the matrix 601 (i.e., the side in which light is emitted from). The lens 420′ includes a plurality of individual light refractors or light controlling devices 612. In an example embodiment, the lens 420′ is arranged close or adjacent to the light emitting matrix array 601 such that light that enters each light refactor 612 is from a single one of the light sources 602. The light refractors 612 can be microprisms, microlenses, beam splitters, or the like. The light refactors 612 can include a plurality of microelectromechanical (MEMS) devices systems. The light refractors 612 can be micro-optical devices formed using a LIGA (Lithographie, Galvanoformung, Abformung) process in the body of a base polymer, e.g., polymethyl methacrylate. In an example embodiment, the light refactors 612 are fixed. In an example embodiment, one or more of the light refractors 612 is different (e.g., having a different refractive index and/or formed of different types of optical structures) than other light refractors 612 (neighboring or elsewhere within the lens 420′. A top row 613 of light refractors 612 (adjacent a top 614 of the lens 420′) may have a first or larger refractive index than lower rows of light refractors 612 (closer to a bottom 615 of the lens 420′). Each subsequent row of light refractors 612 in the lens 420′ below the top row 613 can have a second or lower index of refraction that is lower than the first refractive index (e.g., increasingly lower as a function of increasing distance from the top 614). Columns of the light refactors 612 in the lens 420′ can also vary in index of refraction (e.g., vary from a right hand side 616 to a left hand side 617). The lens 420′ can also include a Fresnel lens. In operation, the refractors 612 individually receive light from an associated light emitter 602 at an input side and refract the light to output individual light beams 618 from an output side. Each light beam 618 is individually focused. The individually focused light beams 618 can be directed to the cold mirror 205, 305.

In an example embodiment, the light refactors 612 are controllable and individually addressable. The light refactors 612 can be liquid crystal lenses (liquid crystals) that can be rotated based on an applied electrical signal or electrical field. A lens controller 620 can control the light refactors 612. In an example, the light refactors 612 can block the light beam 618 for exiting the lens 420′. In an example, the light refactors 612 can redirect the light beam 618 in a controllable manner.

The plurality of light sources 602 of the array 601 can, for example, be VCSELs in an VCSEL array. In an example embodiment, a VCEL array is selected over an LED array. A VCSEL array can pack light sources 602 more densely than LEDs. For example, about one hundred-fifty lasers can be positioned in a VCSEL array with a footprint of about 2 mm×1 mm. A typical LED footprint for an equivalent number of light sources is 2 mm×2 mm. Also, laser light sources output more coherent light than LEDs. In a non-beam steering matrix light application, an advantage of VCSEL is a smaller size and a single chip. Many LED arrays combine multiple LED chips. The use of lasers as light sources 602 also provides improvement for the dynamic beam steering thru the lens 420′, which can be a liquid crystal on silicon (LCOS) device, which is an example of a spatial light modulator. Such a spatial light modulator is configured to provide spatially varying modulation on a beam of light (e.g., light 606), for example by phase modulating the phase of the light beam, which can perform better with coherent light than with a broader spectrum light source such as light from an LED array. Again, the light controlling devices or refractors 612 can be a reflective liquid crystal or LCOS element that provides spatial light modulation, e.g., amplitude, phase, or polarization of light waves in space and time. A VCSEL array can be a single chip package with hundreds of laser sources on it, and each laser source can be addressed individually to turn on, off or any intensity in between. With LED based matrix lighting array, a board with hundreds of LEDs thereon is required. Also, the laser sources can be lensed thru microlenses that are etched on the chip itself. The LEDs need individual lenses for each LED.

Thus, the lens 420′ can include the light refractors 612 (e.g., microlenses) to receive a laser beam from one or two light sources 602 and then steer the light 618 and focus the light 618 as needed.

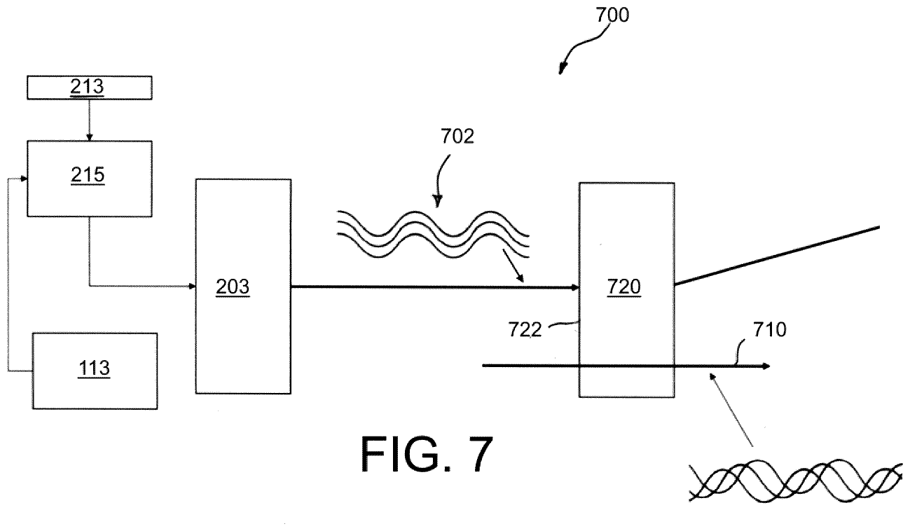

FIG. 7 shows a schematic view of a headlamp system 700 according to an aspect of the present disclosure. The lighting system 700 can be a component of the vehicle 100. The light source 203 can be a coherent light source, e.g. an array of solid state lasers, VCSEL, or the like. The light 702 from the light source 203 is coherent light, e.g., in-phase and polarized. The light 702 is received by a lens 720. The lens 720 can be a crystal steering lens, e.g., a LCOS, which operates better with coherent light to be able to steer all or most of the light 702. If the light source 203 outputs non-coherent light 710, this non-coherent light 710 can be passed through the lens 720 and not be fully steered; however, some of the non-coherent light 710 that is aligned by chance with the polarization of the lens 720 may be steered.

The lens 720, being a liquid crystal or crystal steering lens, operates using polarization of the liquid crystals or liquid crystal lenses 721 (e.g., similar to light controlling devices 612 shown in FIG. 6), which have an inherent polarization due to the internal crystalline structure of liquid crystals which may reject, reflect, and/or attenuate light that is not aligned with such inherent polarization or allow light aligned with such structure to pass through the crystalline structure. Such a liquid crystal lens is referred to as a polarization sensitive spatial light modulator. The liquid crystals are aligned with the polarized coherent light (e.g., light 702) of the light source 203 to maximize the amount of light that can be steered by each crystal. Depending on the kind of the liquid crystal lens, e.g., LCOS, the non-polarized light, or “not correctly” aligned polarized light (e.g., light 710) will just pass through or be scattered by the lens 720. Some LCOS lens also have a polarizer layer 722 to block the non-correctly aligned polarized light 710.

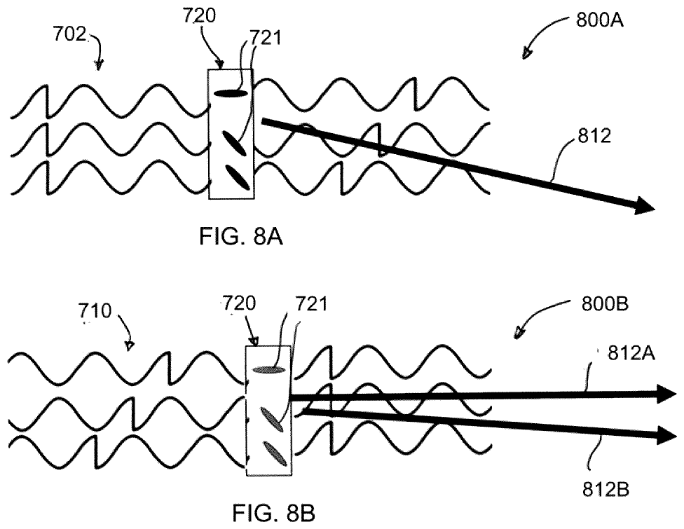

FIGS. 8A and 8B show simplified schematic views of operation of the lens 720, which can be used in a lamp, e.g., as a component of the vehicle 100. View 800A shows the lens 720 receiving coherent light 702 and outputting a steered light beam 812. Various crystals 721 in the lens 720 will steer all of the light 702 to the beam 812. View 800B shows the lens 720 receiving non-coherent light 710 and outputting light beams 812A, 812B including a non-steered beam 812B and a steered beam 812A. The crystals 721 in the lens 720 cannot steer a significant portion of the non-coherent light 710. View 800B shows that some non-coherent light 710 may be steered as there is a probability that some of the non-coherent light 710 is by chance aligned with the liquid crystals 721 in the lens 720 and will be steered. So, in the lens 720, some non-coherent light 710 will get diffused, some light passes through the lens 720 (e.g., non-steered beam 812B), and some non-coherent light 710 gets steered at different angles (e.g., steered beam 812A).

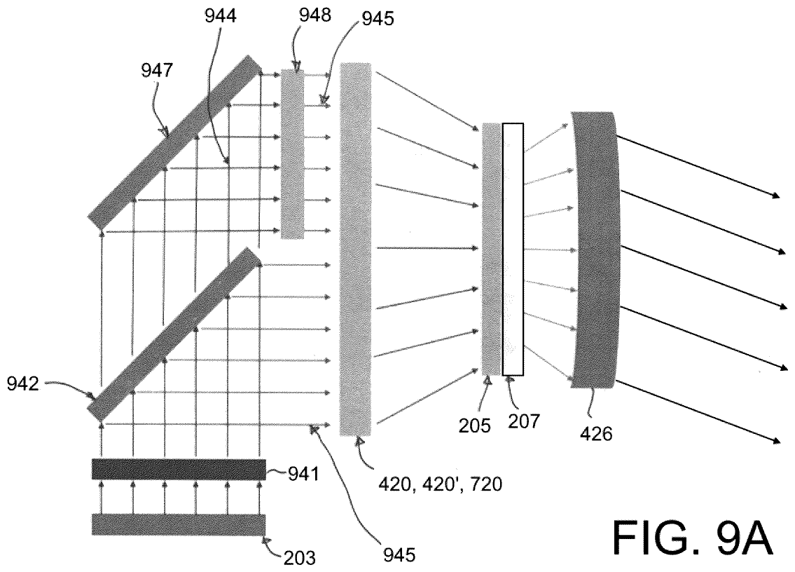

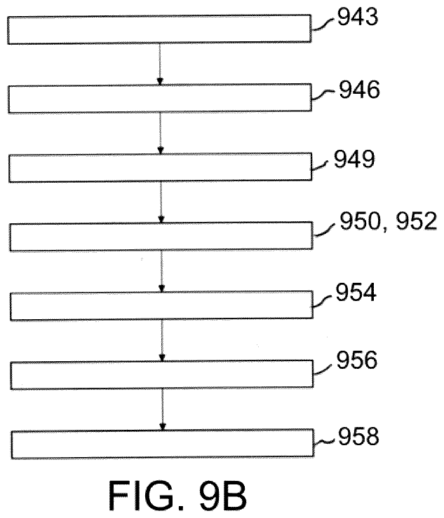

FIG. 9A shows a lighting system 900 for providing polarized, coherent light to the cold mirror 205. FIG. 9B illustrates the operation of the lighting system 900 (controlling light emitted from a light source 203). Again, the solid state light source array 203 can include a plurality of point sources of light, e.g., an array of VCSEL devices. A microlens array 941 (e.g., similar to lens 420, 420′ or micro-optic layer described above) receives the light emitted from the light source array 203. The microlens array 941 can be part of the same package as the light source array or light source 203. The microlens array 941 focuses the light onto a beam splitter polarizer 942 (e.g., angled at 45 degrees relative to the light source 203 and microlens array 941 as shown) (step 943 of FIG. 9B). The beam splitter polarizer 942 splits the received light, e.g., passes the P polarization light 944 (a first polarized coherent light having a first polarization) and reflects the S polarization light 945 (a second polarized coherent light having a second polarization orthogonal to the first polarization) to the lens 420, 720 (step 946 of FIG. 9B). A mirror 947 (e.g., also angled at 45 degrees relative to the light source 203 and microlens array 941 as shown) receives the light 944 passed through the polarizer 942 and reflects the light 944 to a half wave plate 948. The half wave plate 948 shifts the polarized light (e.g., P polarization light 944) to align with the light 945 reflected by the polarizer 942 (e.g., S polarization light 945) (step 949 of FIG. 9B). In other words, the half wave plate 948 polarizes the second polarized coherent light into a third polarized coherent light with the same polarization as the first polarized coherent light. The half wave plate 948 operates so that a portion, e.g., half, of the light intensity is not lost due to it being the incorrect polarization. The lens 420, 720 receives the light 944, 945 from both the polarizer 942 and the half wave plate 948 and can steer (phase modulate) the light 944, 945 to the cold mirror 205 (step 950 of FIG. 9B). As a result, all of the light 944, 945 that reaches the cold mirror 205 is coherent, with the having a same polarization. The light 944, 945 passes through the cold mirror 205 and enters the conversion layer 207 (step 952 of FIG. 9B). The conversion layer 207 can be a down converting layer (e.g., phosphor) when the light is in the blue or ultraviolent spectrum. In an example embodiment, the conversion layer 207 can be a down converting layer when the light is in the red or infrared spectrum. The conversion layer 207 can include dopants that absorb the light 944, 945 and emit light at a different wavelength. In an example embodiment, the dopant can be a phosphor that down converts the light (e.g., absorbs infrared light and emits visible white light) (step 954 of FIG. 9B). The light emitted from the conversion layer can travel in any direction with some light beams headed toward the headlight lens 426 and some light beams headed to the cold mirror 205 (e.g., as described above for FIGS. 2-5). The visible light is reflected by the cold mirror 205 to the headlight lens 426 and focused by the headlight lens 426 (step 956 of FIG. 9B). A controller (not shown in FIG. 9A) can provide dynamic lighting by modulating the intensity of each solid state emitter 204 in the light source array 203 (step 958 of FIG. 9B).

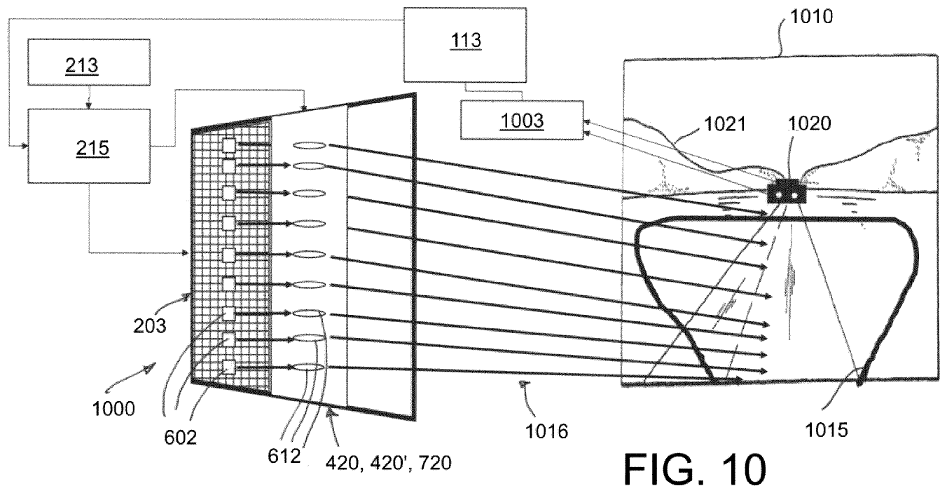

FIGS. 10-13 show schematic views of operation of a vehicle illumination or lamp system 1000 that illuminates an area, senses objects in the area, and controls (e.g., steers) direction of the light output from the system 1000.

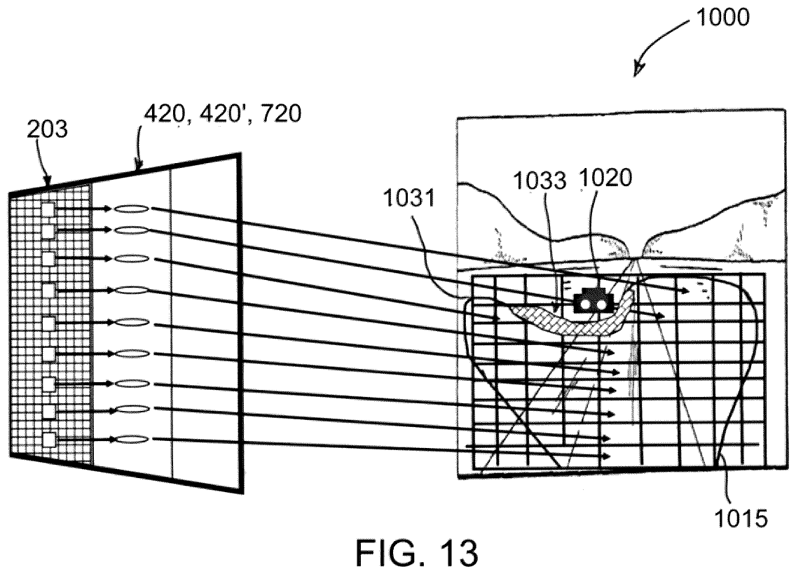

Specifically, FIG. 10 shows a simplified schematic view of the vehicle lamp system 1000 according to an aspect of the present disclosure. The system 1000 has a light source 203 with a plurality of solid state light emitters 602. In more detail, all of the individual, solid state light sources 602 are activated or on and emitting light. The light beams 1016 emitted from the vehicle lamp system 1000 can be directed to the environment around the vehicle, e.g. forward of the vehicle to area 1015 in a forward environment 1010 and some light beams can be directed at an oncoming vehicle 1020 approaching the illuminated area 1015. A sensor 1003 (e.g., a camera), along with associated processing circuitry detects another vehicle (e.g., oncoming vehicle 1020) in the imaged volume of the forward environment 1010. The lens 420, 720 is controlled to individually steer the light beams 1016 from each light source 602 (e.g., on a pixel-by-pixel or individual basis), away from oncoming vehicle 1020 to reduce glare to the oncoming vehicle 1020. This can be done in place of turning off some light sources 602. Compared to matrix lighting where individual light sources (e.g., pixels) are shut off thereby reducing the light on the road, redirecting the light uses all the light (lumens) which is steered to other useful locations rather than shutting any light sources 602 off. The refractory devices or light refractors 612 in lens 420, 420′, 720 can steer each light beam up or down, left or right. This will change the shapes of the illuminated area 1015, but keep the same amount of light output (lumens) while increasing the luminance in the area 1015. In an example embodiment, all of the light sources 602 are on when the lamp or vehicle lamp system 1000 is on. The lens 420, 420′, 720 can operate to direct some light beams 1016 away from the vehicle 1020 when it is determined to be in the illuminated area 1015, e.g., by applying or executing instructions in the camera 1003 and/or the BCM 113. The light beams 1016 that would impinge the oncoming vehicle 1020 are actively directed away from the oncoming vehicle 1020 toward adjacent roadway 1021. In an example embodiment, the light sources 602 that emit light beams 1016 that are directed at the oncoming vehicle 1020 or will be steered away from the oncoming vehicle 1020 can reduce their light output, e.g., reduce the lumens or the luminance. If the light beams 1016 are being steered away from the oncoming vehicle 1020, the light 1016 can be used to illuminate more of the area to the sides of the road, e.g., on the side where the vehicle equipped with the system 1000 is traveling. The light beams 1016 from the vehicle lamp system 1000 can be steered away from the approaching or oncoming vehicle 1020 such that the oncoming vehicle 1020 travels in a darkened spot 1033 (FIG. 13) in the forward environment 1010. This darkened spot 1033 is positioned around the oncoming vehicle 1020 and travels with the oncoming vehicle 1020 through the forward environment 1010. Such a darkened spot 1033 will grow in area as the oncoming vehicle 1020 approaches the light source 203 and disappear when the oncoming vehicle 1020 is no longer in the area 1015, e.g., the oncoming vehicle 1020 passes the present vehicle (i.e., the vehicle equipped with the system 1000) or turns off the present roadway.

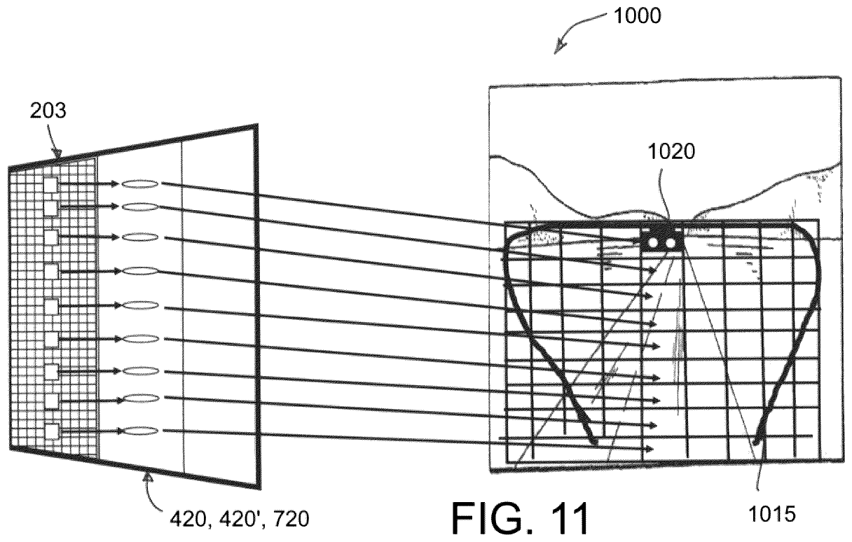

FIG. 11 shows a simplified schematic view of the vehicle lamp system 1000 according to an aspect of the present disclosure. The system 1000 outputs light from the light source array 203. The light is directed by the lens 420, 720. In an example, the lens 420, 420′, 720 includes a refractory matrix with a liquid crystal layer that directs light from pixels (the light source array 203 as multiple point sources) in pattern 1015 ahead of vehicle. The oncoming vehicle 1020 is in the illuminated area 1015. The lamp has not steered the light beams away from the oncoming vehicle 1020.

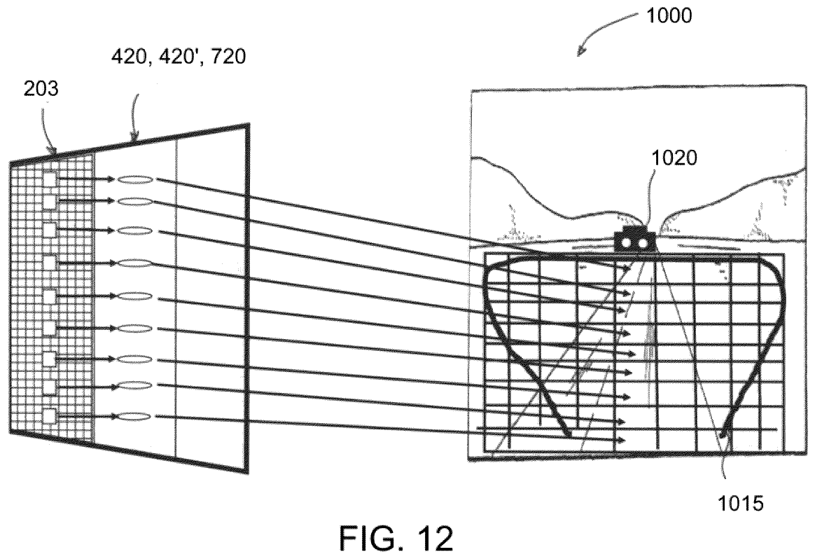

FIG. 12 shows a simplified schematic view of the vehicle lamp system 1000 according to an aspect of the present disclosure. The vehicle lamp system 1000 shows that the light output is steered downward away from the oncoming vehicle 1020. The light is directed downwardly to mimic low beams of an incandescent headlamp. The illuminated area 1015 is smaller than the illuminated areas 1015 in FIGS. 10 and 11. The lens 420, 420′, 720 e.g., a liquid crystal layer (LCL), directs light downwards away from the oncoming vehicle 1020. Thus, the oncoming vehicle 1020 is outside the illuminated area 1015.

The examples described herein refer to an oncoming vehicle 1020 and changing the illuminated area 1015, so as to reduce glare for the oncoming vehicle 1020. However, the present examples are not so limited. The system 1000 could detect any other vehicle on the roadway, either oncoming or traveling in the same direction, and change the illuminated area to reduce glare for the other vehicle.

FIG. 13 shows a simplified schematic view of the vehicle lamp system 1000 according to an aspect of the present disclosure. The system 1000 has all of the light sources on and emitting light, even those that have light directed at the oncoming vehicle 1020 in the illuminated area 1015. The lens 420, 420′, 720 can operate to direct some light beams away from the oncoming vehicle 1020. All light sources in the light array 203 are emitting light. The light beams that would impinge the vehicle 1020 are actively directed away from the vehicle 1020 toward an area 1031 adjacent the roadway. In an example embodiment, the light sources 203 that emit light that is directed at the oncoming vehicle 1020 or will be steered away from the oncoming vehicle 1020 can reduce their light output, e.g., reduce the lumens or the luminance. If the light beams are being steered away from the oncoming vehicle 1020, the light can be used to illuminate more of the area to the sides of the road, e.g., on the side where the vehicle equipped with the system 1000 is traveling. The light from the vehicle lamp system 1000 can be steered away from the oncoming vehicle 1020 such that the vehicle 1020 travels in the darkened spot 1033 in the forward environment 1010. This darkened spot 1033 is positioned around the oncoming vehicle 1020 and travels with the oncoming vehicle 1020. Such a darkened spot 1033 will grow in area as the vehicle 1020 approaches the vehicle lamp and disappear when the oncoming vehicle 1020 is no longer in the area 1015, e.g., the oncoming vehicle 1020 passes the present vehicle (i.e., the vehicle equipped with the system 1000) or turns off the present roadway.

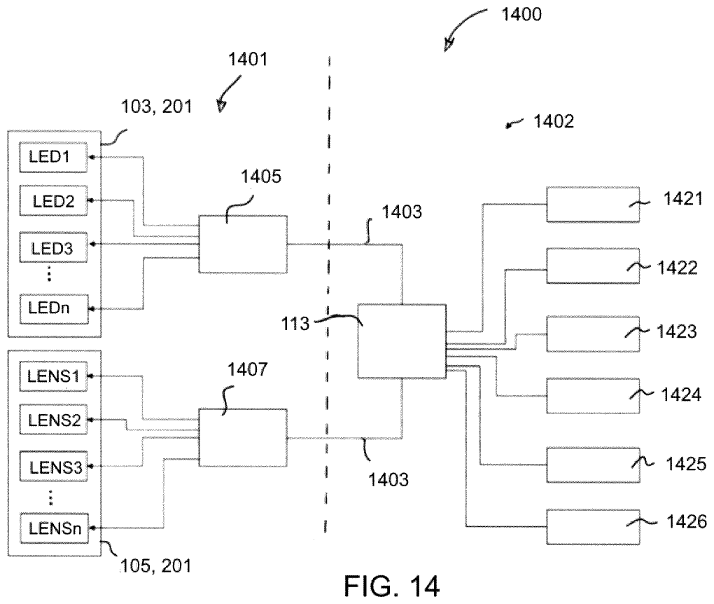

FIG. 14 shows a simplified schematic view of a vehicle 1400 according to an aspect of the present disclosure. The vehicle 1400 includes a lamp side 1401 and a vehicle side 1402, which are connected by a vehicle communication channel 1403, e.g., wiring or the controller area network (CAN) bus. The lamp side 1401 includes a lamp controller 1405 to control operation of each of the light sources in the light source array or matrix 103, 201 (of a plurality of LEDs LED₁, LED₂, LED₃, . . . LED_{N}). The lamp side 1401 also includes a lens controller 1407 controls operation of the refractory devices or light controlling devices, here lenses, to control the direction of the light emitted from the lamp side 1401. The BCM 113 is on the vehicle side 1402 and sends control signals to both the light controller 1405 and the lens controller 1407. The BCM 113 includes processing circuitry (e.g., a microprocessor) that is operable connected to a memory. Task instructions for the BCM 113 are stored in the memory and loaded to the processing circuitry. The BCM 113 receives sensed input values from various vehicle sensors 1421, 1422, 1423, 1424, 1425, 1426, e.g., a steering angle sensor 1421, a camera 1422, a light sensor 1423, a speed sensor 1424, a light detection and ranging (LIDAR) sensor 1425, driver settings 1426, and others. While only one of each is shown, it should be appreciated that multiple types of each vehicle sensor 1421, 1422, 1423, 1424, 1425, 1426 may be utilized instead. The BCM 113 applies the instructions to the inputs and outputs commands for the light controller 1405 and the lens controller 1407, which in turn apply their own instructions to generate control signals applied to the light source array or matrix 103, 201 (of a plurality of microlenses LENS₁, LENS₂, LENS₃, . . . LENS_{N}) and the array of light controlling devices or refractory matrix 105, 201.

The present disclosure describes the light direction controlling devices or structures as a lens. Such a lens can also include a refractory matrix of optical controlling structures, e.g., prisms, waveguides, shutters, mirrors and the like.

The foregoing description of the embodiments describes some embodiments with regard to lighting systems for vehicles. These are used for convenience of description. The present disclosure is applicable to solid state lights requiring a controllable lens to steer light rays emitted from the lamp or light sources.

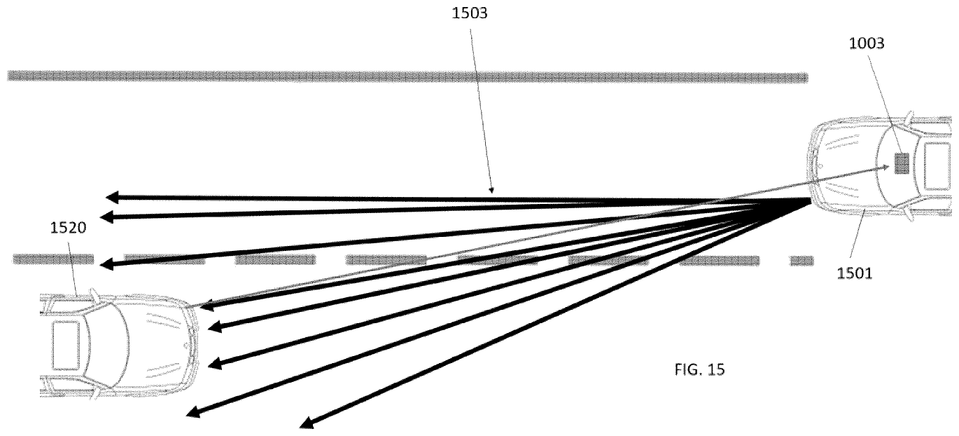

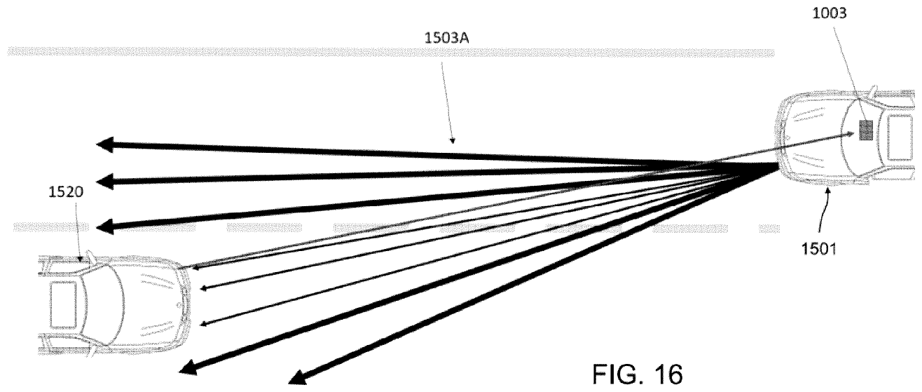

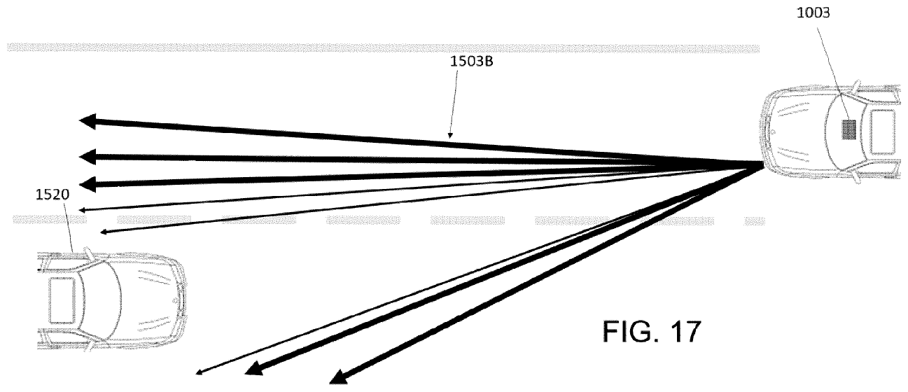

FIGS. 15-17 show the operation of the vehicle lamp system 1000 or vehicle 1400 from above. A vehicle 1501 is traveling on a roadway and is emitting a light pattern 1503 according to the systems and methods described herein to illuminate the environment in front of the vehicle 1501. The light pattern 1503 includes a plurality of light beams projected from the light source 203 and controlled by the lens 420, 420′, 720. The vehicle 1501 includes an imaging device 1003, e.g., a camera, to sense an oncoming vehicle 1520. The vehicle 1501 senses the oncoming vehicle 1520 and changes the light pattern to light pattern 1503A (FIG. 16). The light pattern 1503A and/or 1503B differs from light pattern 1503. The difference between light pattern 1503 and 1503A is that the light beams directed at the oncoming vehicle 1520 are dimmed or turned off. In another example embodiment, the difference is the light beams 1503B that would be directed at the vehicle 1520 are steered to not impinge the oncoming vehicle 1520. Such steered light beams 1503B are illustrated in FIG. 17 with reduced thickness and not impinging the vehicle 1520.

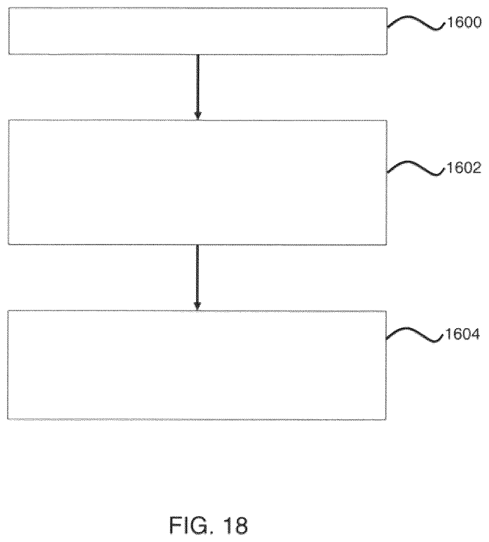

Referring back to FIG. 9B along with FIG. 18 a method of optically steering light emitted from a vehicle lamp 103, 105, 201, 300, 600 is also provided. The method includes the step of 1600 generating a coherent light using a light source 203. The method continues with the step of 943 focusing the coherent light from the light source 203 using a microlens array 941 adjacent the light source 203. The method continues with the step of 1602 aligning a polarization direction of the coherent light with a polarization direction of a spatial light modulator 420, 420′, 720 using a polarizer 942, 948 to form a polarized coherent light. In more detail, the step of 1602 aligning the polarization direction of the coherent light with the polarization direction of the spatial light modulator 420, 420′, 720 using the polarizer 942, 948 to form the polarized coherent light includes the step of 946 polarizing the coherent light into a first polarized coherent light (e.g., P polarization light 944) and a second polarized coherent light (e.g., S polarization light 945) using a beam splitting polarizer 942 of the polarizer 942, 948. The method can also include the step of 949 polarizing the second polarized coherent light (e.g., S polarization light 945) into a third polarized coherent light using a half wave plate polarizer 948 of the polarizer 942, 948, wherein a polarization of the first polarized coherent light and the third polarized coherent light are the same and form the polarized coherent light. The next step of the method is 1604 modulating the polarized coherent light using the spatial light modulator 420, 420′, 720 to optically steer the polarized coherent light emitted from the light source 203 (also see step 950 of FIG. 9B). Specifically, the method can include the steps of receiving the polarized coherent light using a cold mirror 205 and 952 allowing a first band of light with a first range of wavelengths to pass therethrough and reflecting a second band of light with a second range of wavelengths different than the first range of wavelengths using the cold mirror 205. Next, the method includes the steps of receiving the first band of light using a conversion layer 207 and 954 converting the first band of light to a converted light with a wavelength in a visible wavelength range using the conversion layer 207. The method can proceed by 956 focusing the converted light by a headlight lens 426.

In addition, as discussed above, the light source 203 can include solid state emitters 204, 504, 602 (e.g., a laser of VCSEL array 525). Consequently, the method further includes the step of receiving sensed signals from vehicle sensors 115, 1003, 1421, 1422, 923, 1424, 1425, 1426 in communication with the vehicle lamp 103, 105, 201, 300, 600. Next, 958 adjusting an amount of light output by the each of the solid state emitters 204, 504, 602 based on the sensed signals from the vehicle sensors 115, 1003, 1421, 1422, 923, 1424, 1425, 1426.

Embodiments of the present disclosure may improve a vehicle headlamp by providing a light, thin device that can be applied to the vehicle. The headlamp can include a matrix of light emitters with each paired to a microlens. The light emitters can be individually controlled. A plurality of the microlenses can be controlled to guide the light rays emitted from the headlamp. For example, some microlenses can alter the direction of the light rays to change the output from an expanded light beam (e.g., a high beam) to a narrowed beam (e.g., a dimmed beam). However, the total output of the emitters is not reduced. That is, the headlamp can continue to output the same lumens. This can hold solid state light emitters in an optimal state, e.g., the driving electrical signal that holds the solid state in its emitting state may be less (voltage and/or current) than the electrical signal to turn the emitter on.

The light sources and light emitters described herein emit radiation in the electromagnetic spectrum, which is the range of frequencies of electromagnetic radiation and their respective wavelengths and photon energies. In some embodiments, the emitted radiation is in the visible light spectrum, e.g., about a wavelength between 380 nm and 760 nm (400-790 terahertz) which is detectable by the human eye and perceived as visible light. The light sources and emitters can emit other wavelengths, e.g., near infrared (longer than 760 nm) and ultraviolet (shorter than 380 nm), which can be referred to as light. In an example, the light sources and emitters emits a broad spectrum light, e.g., a white light, which is a combination of lights of different wavelengths in the visible spectrum. In an example embodiment, the light sources and emitters as described herein emit electromagnetic radiation ata wavelength greater than ionizing radiation, e.g., near ultraviolet and longer wavelengths.

The foregoing description of the embodiments has been provided for purposes of illustration and description. It is not intended to be exhaustive or to limit the disclosure. Individual elements, assemblies/subassemblies, or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof.

The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items. Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” “top”, “bottom,” and the like, may be used herein for ease of description to describe one element's or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptions used herein interpreted accordingly.

What is claimed is:

1. A vehicle lamp, comprising:
a light source including solid state emitters, the solid state emitters are configured to emit light at a portion of a light spectrum;
a cold mirror receiving the light emitted from the solid state emitters and passing the light therethrough;
a conversion layer receiving the light from the cold mirror, wherein the conversion layer is configured to convert the light from the cold mirror to a visible light, a first portion of the visible light traveling to the cold mirror and being reflected by the cold mirror to exit the vehicle lamp and a second portion of the visible light traveling from the conversion layer out of the vehicle lamp; and
a controller to control the solid state emitters.

2. The vehicle lamp of claim 1, wherein the solid state emitters are each individually controllable by the controller.

3. The vehicle lamp of claim 1, wherein the light emitted from the solid state emitters is an ultraviolet light, and wherein the conversion layer is configured to down convert the ultraviolet light to the visible light.

4. The vehicle lamp of claim 3, further comprising a lens intermediate the light source and the cold mirror to control a direction of the light from the solid state emitters.

5. The vehicle lamp of claim 4, wherein the lens includes individual light controlling devices are each individually controllable to control the direction of the light from the light source.

6. The vehicle lamp of claim 4, wherein the controller receives position information of another vehicle and controls the direction of the light by controlling the solid state emitters, the lens, or both to direct the light away from the another vehicle.

7. The vehicle lamp of claim 6, wherein the lens include liquid crystal lenses.

8. The vehicle lamp of claim 1, wherein the solid state emitters are controlled to adjust an amount of lumens being output from the light source and emit the light in a visible portion of the light spectrum.

9. The vehicle lamp of claim 1, wherein the cold mirror includes alternating layers having different indexes of refraction.

10. A vehicle lamp assembly, comprising:
a light source including solid state emitters, the solid state emitters are configured to emit electromagnetic radiation;
a micro-optic layer optically connected to the light source, wherein each solid state emitter is optically coupled to the micro-optic layer to control a direction of the electromagnetic radiation emitted from the light source;
a cold mirror receiving the electromagnetic radiation emitted from the solid state emitters from the micro-optic layer and passing the electromagnetic radiation therethrough;
a conversion layer receiving the electromagnetic radiation from the cold mirror, wherein the conversion layer is configured to convert the electromagnetic radiation to a visible light, a first portion of the visible light traveling to the cold mirror and being reflected by the cold mirror to exit the vehicle lamp assembly and a second portion of the visible light traveling from the conversion layer out of the vehicle lamp assembly; and
a controller configured to control the solid state emitters.

11. The vehicle lamp assembly of claim 10, wherein the controller is further configured to control the on state of each of the solid state emitters.

12. The vehicle lamp assembly of claim 11, wherein the controller receives sensed signals from vehicle sensors and controls operation of each of the solid state emitters.

13. The vehicle lamp assembly of claim 10, wherein the micro-optic layer is a microprism layer including a plurality of controllable elements to direct an electromagnetic radiation output from the solid state emitters, and wherein the controller is further configured to control a state of the plurality of controllable elements.

14. The vehicle lamp assembly of claim 13, wherein the micro-optic layer includes a plurality of liquid crystal lenses.

15. The vehicle lamp assembly of claim 10, wherein the solid state emitters include an array of vertical-cavity surface-emitting laser elements.
